(19) United States
(12) Patent Application Publication
(10) Pub. No.: US 2011/0262717 A1
(43) Pub. Date: Oct. 27, 2011

(54) MULTI-LAYER FILM DEPICTING A COLOUR TWO-DIMENSIONAL IMAGE WHICH IS ONLY VISIBLE THROUGH A POLARIZING FILTER AND PROCESS FOR MAKING THE FILM

(75) Inventors: Martin Eduardo Broen, Milano (IT); Emanuele Teobaldo, Castel Gandolfo (IT); Enrico Girotti, Cesena (IT); Giacomo Melani, Milano (IT)

(73) Assignee: LUXOTTICA S.R.L., 32021 Agordo (IT)

(21) Appl. No.: 13/139,381

(22) PCT Filed: Dec. 23, 2009
(86) PCT No.: PCT/IB09/55938

§ 371 Date: Jul. 11, 2011

(30) Foreign Application Priority Data
Dec. 23, 2008 (IT) BO2008A000771

(51) Int. Cl. B32B 3/10; B29C 65/02; C09J 5/02

(52) U.S. Cl. 428/195.1; 156/322; 156/499

(57) ABSTRACT

A film (1) depicting a colour two-dimensional image which is only visible through a polarizing filter comprises an optically active layer (2) placed over a polarizing layer (3) and configured to form said image on its face opposite the polarizing layer (3) when said face is seen through the polarizing filter; the optically active layer comprises a plurality of areas (4) arranged side by side in said face to form corresponding portions of the image, each area (4) being mechanically stressed to a predetermined intensity so that the corresponding portion of the image has a predetermined colour when seen through the polarizing filter. Also described is an apparatus (6) for making the film (1).

### TECHNICAL FIELD

This invention relates to a multi-layer film depicting a colour two-dimensional image which is only visible through a polarizing filter and a process for making the film.

In particular, the invention addresses the field of devices used for advertising or demonstration purposes and having optical properties such as to allow images to be viewed only through polarizing filters such as, for example, polarized sunglass lenses.

### BACKGROUND ART

In this field, labels and cards are known which are used for demonstration purposes in the sale of glasses with polarized lenses and which comprise multi-layer structures consisting of a polarizing layer with a transparent sheet bearing an image applied to it.

Owing to the polarizing layer behind the sheet bearing the image, the image is visible only through glasses with polarized lenses.

These solutions have the drawback of allowing images to be viewed only in black and white or shades of grey.

It should also be noted that an art form known as “polage” is used by American artist Austine Wood Comarow to create coloured images.

According to the polage technique, pieces of cellulose are cut and arranged in mosaic style to form a layer placed on a transparent surface. The rear face of the mosaic is irradiated with polarized light. A polarizing screen is rotated in front of the front face of the mosaic.

The effect obtained is that of a coloured image that changes over time according to the angle of rotation of the polarizing screen relative to the orientation of the polarized light.

The polage technique exploits the optical properties of cellulose, which is an optically active material.

Optically active materials are materials which, when crossed by a ray of polarized light, rotate the orientation of polarization of the light ray. The type of rotation depends on the nature and thickness of the specific material crossed by the ray. This optical property is also known as birefringence.

Polage, however, is a technique for creating images that change over time and is not concerned with creating devices that reproduce images (used for advertising purposes or of a promotional nature) which are visible only through polarizing screens.

Moreover, polage is an extremely complicated technique because the size of the cellulose pieces determines the resolution of the image obtained: the higher the resolution required for the image the smaller the pieces of cellulose must be cut.

That also significantly limits the resolution which can be obtained for the images and the variety of colour shades which can be produced.

Polage, therefore, which was developed as a form of art, would be inconvenient and unsuitable for adaptation to an industrial application.

### DISCLOSURE OF THE INVENTION

This invention has for an aim to provide a multi-layer film depicting a colour two-dimensional image which is only visible through a polarizing filter and a process for making the film, which overcome the above-mentioned disadvantages of the prior art.

In particular, this invention has for an aim to provide a film depicting a colour two-dimensional image which is only visible through a polarizing filter which has a particularly simple construction and at the same time depicts high resolution images.

This invention also has for an aim to provide such a film showing images with a particularly high level of resolution and colour gradation.

Said film is a film depicting a colour two-dimensional image which is only visible through a polarizing filter, having an optically active layer placed over a polarizing layer and configured to form said image on its face opposite the polarizing layer when said face is seen through the polarizing filter.

This invention also has for an aim to provide a process for making such a film depicting high resolution images in a particularly effective way, so that the process can be used at industrial level.

Yet another aim of this invention is to provide a process for making such a film which is particularly easy to implement automatically.

This invention also has for an aim to provide a process for making such a film, which allows the production of images with a particularly high level of resolution and colour gradation.

Said process is a process for making a multi-layer film depicting a colour two-dimensional image which is only visible through a polarizing filter, comprising the following steps:
preparing a polarizing layer;
preparing an optically active layer;
placing the optically active layer over the polarizing layer, the optically active layer being configured to form said image on its face opposite the polarizing layer when said face is seen through the polarizing filter.

Yet another aim of the invention is to propose an apparatus for making such a film at industrial level.

Said aims are fulfilled by the film according to this invention, having the features described in the appended claims and in particular being characterised in that the optically active layer comprises a plurality of areas arranged side by side in said face to form corresponding portions of the image, each area being mechanically stressed to a predetermined intensity so that the corresponding portion of the image has a predetermined colour when seen through the polarizing filter.

The process according to this invention is characterised in that preparation of the optically active layer comprises the following steps:
preparing a sheet of plastic material;
treating a plurality of areas of the sheet to assign each area a mechanical stress of predetermined intensity, said areas being arranged side by side in said face to form corresponding portions of the image, so that the corresponding portion of the image has a predetermined colour when seen through the polarizing filter.

### BRIEF DESCRIPTION OF THE DRAWINGS

These and other features of the invention will become more apparent from the following detailed description of a preferred, non-limiting example embodiment of it, with reference to the accompanying drawings, in which:

FIG. 1 illustrates a film made according to this invention;

FIG. 2 is a cross-section of the film of FIG. 1;

FIG. 3 illustrates an apparatus made according to the invention for making the film of FIG. 1.

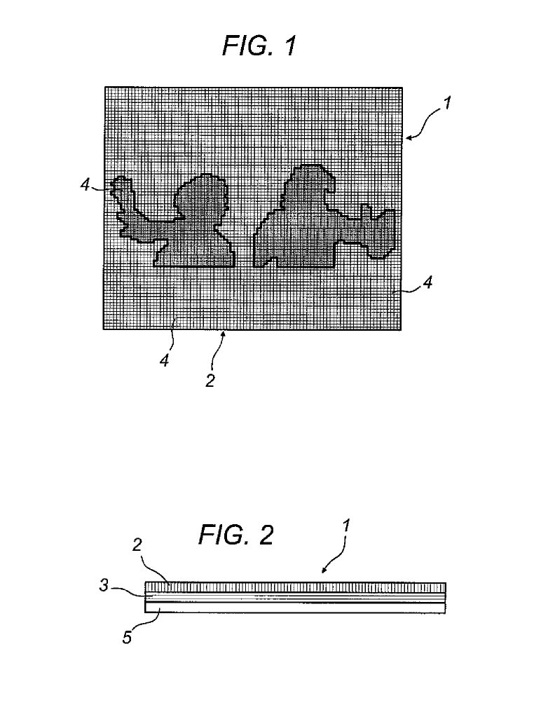

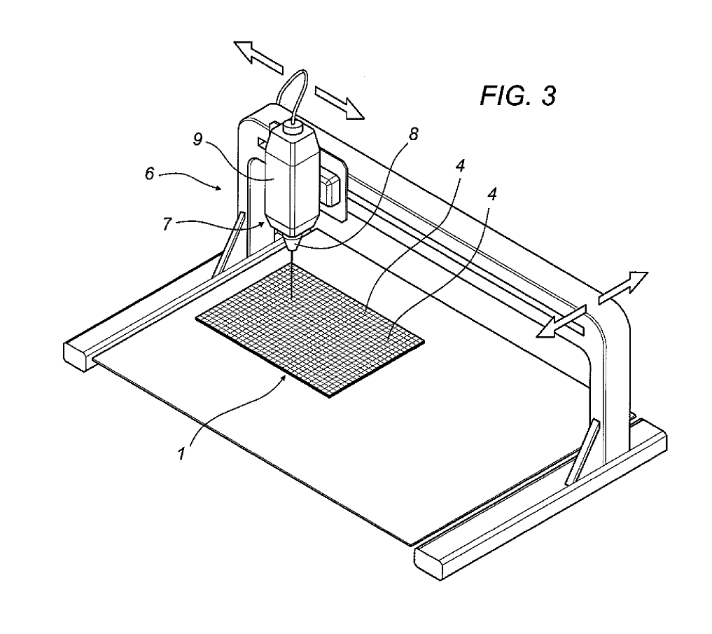

### DETAILED DESCRIPTION OF THE PREFERRED EMBODIMENTS OF THE INVENTION

The numeral 1 in the drawings denotes a film according to the invention.

The film 1 is a multi-layer film depicting a colour two-dimensional image which is only visible through a polarizing filter.

The film 1 comprises an optically active layer 2, that is to say, a layer which, when crossed by a ray of polarized light, rotates the orientation of polarization of the light ray coming out of the layer.

The film 1 also comprises a polarizing layer 3 (of the known type).

The optically active layer 2 is placed over the polarizing layer 3. In particular, a rear face of the optically active layer 2 is in contact with the polarizing layer 3.

The optically active layer 2 is configured to form the desired image on its front face which is opposite the polarizing layer. Said image is displayed on the front face of the optically active layer 2 when that face is seen through a polarizing filter.

The optically active layer 2 is configured in such a way that it has different optical properties depending on the areas of the layer 2. In that way, the rays of light which cross the optically active layer 2 are subjected to rotations of the orientation of the respective polarizations depending on the area of the optically active layer 2 they cross. Such rotations in the orientation of the polarizations of the various rays of light cannot be seen with the naked eye, therefore the image is invisible (that is to say, encrypted).

In contrast, when a polarizing filter is interposed between the eyes of the observer and the optically active layer 2, of the rays crossing the polarizing filter 2, only those whose orientation of polarization is the same as that of the filter are transmitted, whilst the others are stopped by the filter. That causes the image to be seen.

Therefore, the polarizing filter forms means for decrypting the image created in an encrypted form on the front face of the optically active layer 2.

Therefore, the optically active layer 2 is configured to form the image on its front face opposite the polarizing layer 3 when said face is seen through the polarizing filter.

In particular, the optically active layer 2 comprises a plurality of areas 4 positioned side by side relative to the surface of the polarizing layer 3, that is to say, side by side on the front face (opposite the polarizing layer 3) of the optically active layer 2, forming corresponding portions of the image.

The meaning of the expression “side by side areas 4” should be explained.

The optically active layer 2 has a surface of extension (forming the front face of the layer) and a thickness, understood to be the layer dimension perpendicular to the surface of extension. The areas 4 are positioned side by side in the sense that they are placed on the surface of extension of the layer. Therefore, each area 4 is spaced relative to the others along the surface of extension, whilst all of the areas 4 substantially have the same thickness, equal to the thickness of the layer 2. It should also be noticed that this invention does not require any type of action for “placing side by side” portions of the layer 2 to form the areas 4. The areas 4 are formed by means of selective treatment of the layer 2, which is a continuous layer, a single block. The layer 2 is not in any way made up of a mosaic of portions which are connected to each other (by “placing them side by side”).

According to the invention, each area 4 is mechanically stressed to a predetermined intensity so that the corresponding portion of the image has a predetermined colour when seen through the polarizing filter.

The mechanical stress applied to a sheet of plastic material gives it the optical property of birefringence.

With regard to this, it should be noticed that the optical properties (of birefringence) of an optically active material consisting of a mechanically stressed sheet of plastic material vary according to the value (or extent) of the mechanical stress.

Therefore, according to the invention the optically active layer 2 has a plurality of areas 4 in which the mechanical stress has different values.

In light of this, the invention comprises two embodiments, regarding the type of material used to make the optically active layer 2, or regarding the process used to make the optically active layer 2.

According to a first embodiment, the optically active layer 2 comprises a sheet of plastic material which is mechanically pre-stressed in a predetermined direction.

The optically active layer 2 is preferably made of PET-G. PET-G (commercially available) is made using an extrusion (or rolling) process, which makes it optically active.

According to a second embodiment, the optically active layer 2 comprises a sheet of plastic material which originally is not mechanically stressed, and which is subsequently selectively mechanically stressed in the various areas 4, that is to say, it is subjected to mechanical stresses of different intensities (i.e., values) depending on the area 4 (obviously, some areas 4 are not stressed at all).

Therefore, this invention comprises selectively removing mechanical stress from a sheet of pre-stressed plastic material, or selectively adding mechanical stress to an unstressed sheet of plastic material, to create an optically active layer 2 having variable optical properties on its surface (with different values depending on the area 4) so as to form a desired colour image.

It should be noticed that an optically active material (in particular a sheet or a layer 2 of optically active material) forms a preferred direction of optical activity, being designed to rotate by a predetermined angle the orientation of a polarized ray of light crossing it, according to an orientation of the preferred direction of optical activity. According to the invention, said predetermined angle depends on the mechanical stress value set for each of the areas 4, therefore it varies from one area to another.

The plastic material of which the film is made (for example PET) may have various degrees of stiffness. The plastic material of which the film is made may be particularly flexible (for example with thicknesses of around 1 mm for the optically active layer 2) or it may be substantially stiff (for example with thicknesses of more than 5 mm for the optically active layer 2). In the latter case, the film consists of a rigid plate.

According to another aspect of the invention, at least one of the areas 4 comprises (preferably all of the areas 4 comprise) in turn a plurality of smaller portions, into which the area is divided (said portions are positioned side by side in the surface formed by the area 4).

Said portions of the area 4 have mechanical stress levels corresponding to two or more reference values and are positioned side by side in the surface formed by the area 4 in such a way that the adjacent portions have different levels of mechanical stress.

In that way, at a predetermined distance from the film, the portion of the image corresponding to the area is perceived to have a colour corresponding to an intermediate mechanical stress level value relative to the reference values.

It should be observed that said technique can be used to produce a colour effect similar to that used by impressionist painters.

The film 1 also comprises an adhesive layer 5 applied to a rear face of the polarizing layer 3 opposite the optically active element 2, for applying the film 1 to a transparent support (for example a piece of glass), the film thus constituting a transparency. The adhesive layer 5 is preferably a sheet of electrostatic (electrostatically charged) material, designed to allow the film 1 to adhere to the surface of a piece of glass.

As an alternative to the adhesive layer, it is possible to apply to the rear of the polarizing layer 3 a reflective screen or a light emitter, depending on the film application.

This invention also provides a reel comprising a film 1 (made as described above), wherein the optically active layer 2 is configured in such a way as to form a plurality of images side by side along a direction of extension of the film 1, the film 1 being wound about an axis perpendicular to said direction of extension to form the reel.

Advantageously, this allows large quantities of film to be made available, which are easy to transport and store, for the large-scale production of transparencies.

This invention also provides a process for making a multi-layer film 1 depicting a colour two-dimensional image (or a plurality of images) which is only visible through a polarizing filter.

The process comprises the following steps:
preparing the polarizing layer 3;
preparing the optically active layer 2;
placing the optically active layer 2 over the polarizing layer 3, the optically active layer 2 being configured to form said image on its front face opposite the polarizing layer 3 when said face is seen through the polarizing filter.

According to the invention, preparation of the optically active layer 2 comprises the following steps:
preparing a sheet of plastic material;
treating a plurality of areas 4 of the sheet to assign each area 4 a mechanical stress of predetermined intensity.

The areas 4 are arranged side by side in the front face to form corresponding portions of the image, so that each portion of the image, when seen through the polarizing filter, has a predetermined colour correlated to the mechanical stress value assigned to the corresponding area 4 of the optically active layer 2.

As regards preparation of the optically active layer 2, the process comprises two embodiments.

According to a first embodiment, the sheet subjected to the treatment is a sheet of plastic material which has been mechanically stressed in a predetermined direction.

The treatment step comprises transferring thermal energy, according to predetermined quantities for each area 4 of the sheet (which therefore form corresponding areas 4 of the optically active layer 2).

In light of this, the process preferably also comprises a preliminary calibration step, for associating sheet mechanical stress intensity values, corresponding to film desired optical properties, with corresponding values of thermal energy to be transmitted to the sheet.

The calibration is preferably carried out based on a grey scale.

Operatively, the (colour) image to be depicted on the film is converted into grey scale. During the treatment step, the white portions of the image are not subjected to heating (minimum, that is to say, zero thermal energy transmitted), whilst the black portions of the image are subjected to maximum heating (maximum thermal energy transmitted), according to the value set during the calibration step.

It should be noticed that the optical properties given to the material during the treatment step depend on the amount of stress accumulated by the material (that is to say, by the area 4 of the layer 2).

The amount of stress accumulated depends on the following factors:
thermal power transmitted;
duration of the treatment of an area 4 (that is to say, period of time during which that heat power is applied to the area 4);
thickness of the sheet (that is to say, of the optically active layer 2).

The thermal power is the parameter which is used to check the treatment step (in feedback).

Regarding the thickness of the sheet, in-depth research and experimentation by the Applicant allowed the identification of the following preferred ranges of values.

The thickness value of the optically active layer 2 is preferably greater than 900-3500 microns. More preferably, the thickness value is at least 1800 microns. Even more preferably, the thickness value is at least 3000 microns (that is to say, approximately 3 millimetres).

It was discovered that with particularly small thickness values, the portions of material affected by the treatment deform due to the localised heating. That prevents uniform heating and consequently uniform assignment of optical properties to the material (that is to say, a uniform reduction of the mechanical stress value of the optically active layer 2, in the area 4 or its affected portion).

According to a second embodiment, the sheet is a sheet of plastic material (originally free of mechanical stress).

In this case, the treatment step comprises a mechanical action (for example using scratching or other mechanical actions e.g. involving the removal of portions of material) on the surface of the sheet, with a predetermined force for each area, to assign each area a mechanical stress of predetermined intensity.

According to another aspect of this invention, the optically active layer 2 is prepared so that it forms a plurality of images side by side along a direction of extension of the film.

Advantageously, this allows the production of a very long film.

In light of this, there is a step of cutting the film 1 along cutting planes which are perpendicular to the direction of extension of the film, to obtain a plurality of segments of film 1, in a continuous process.

Alternatively to the cutting step, the process comprises a step of winding the film 1 about an axis which is perpendicular to the direction of extension to form a reel (from which it is possible to obtain segments of film corresponding to the desired images, at any time as required).

Therefore, the process according to the invention is particularly suited to the industrial level production of film 1 (in the form of segments or reels). The process described above is fully automated and continuous.

This invention also provides an apparatus 6 for making the film 1; that is to say, for making a multi-layer film depicting a colour two-dimensional image which is only visible through polarizing filters.

The apparatus 6 comprises:
a feeder (not illustrated, for example comprising a conveyor belt of the known type) for feeding sheets of plastic material (which may be pre-stressed, that is to say, optically active, or unstressed, depending on the embodiment) to a treatment station;
means for selectively assigning to a plurality of areas 4 of the sheet 2 (arranged side by side in the face to form corresponding portions of the image) a mechanical stress of predetermined intensity, so that the corresponding area 4 of the image has a predetermined colour when seen through the polarizing filter;
means for placing a polarizing layer 3 in a gluing station (said means are not illustrated, for example comprising a conveyor belt or a movement roller of the known type);
a gluer (not illustrated, for example comprising adhesive liquid dispensers operating in conjunction with a movement roller for the layers) configured for applying the optically active layer 2 to the polarizing layer 3 in the gluing station.

According to the first embodiment of the optically active layer 2, the means for selectively assigning each of the areas 4 of the sheet (or sub-portions of it) mechanical stresses of predetermined intensity comprise a heater 7 configured to transfer thermal energy to portions of the sheet, according to predetermined quantities for each area 4.

The sheet is a sheet of plastic material mechanically stressed in a predetermined direction.

The heater 7 preferably comprises a laser emitter 8. The laser emitter is connected to one end of a slider 9 able to move along a surface in such a way that the laser emitter 8 can be positioned above any area 4 of the optically active layer 2.

As an alternative to the laser emitter 8, a nozzle connected to a hot air source may be used.

According to the second embodiment of the optically active layer 2, the means for selectively assigning each of the areas 4 of the sheet (or sub-portions of it) mechanical stresses of predetermined intensity comprise a scratcher (not illustrated in the drawings, for example comprising a blunt instrument connected to the end of a robotized arm) configured to transfer mechanical energy to portions of the sheet, according to predetermined quantities for each area 4.

The film according to this invention has many applications, including in particular those indicated below.

A first application is the transparency, that is to say, application of the film on a transparent support (for example a piece of glass).

Another application is a glasses case, made using the film according to the invention and bearing encrypted images and text.

Another application is a mirror comprising the film made according to this invention which is applied to a frame or in any case coupled to the mirror so that a person looking in the mirror while wearing glasses having polarized lenses can see the images and texts on the film, realising that they would be invisible if he or she were not wearing the glasses.

Another application is a lamp with the film according to this invention applied to the lampshade, so that the light from the lamp passes through it. In that way, the encrypted images in the film are highlighted when the lamp is switched on, creating a very pleasant effect and without limiting the effectiveness of illumination by the lamp.

Another application is a rigid support with a light source positioned behind the film applied to the support, for forming a picture or advertising poster or illuminated sign.

The invention offers the following advantages.

The film 1 bears encrypted colour images which are only visible through polarizing filters, the filters consisting for example of glasses with polarized lenses.

Therefore, the film 1 is particularly suitable for the above-mentioned applications, especially for advertising purposes for selling such glasses.

Its construction being particularly simple, the film 1 allows use on a vast scale.

Despite its simple construction, the film 1 allows a particular quality and resolution of the encrypted images formed by the film, thanks to the creation of areas 4 with extremely small dimensions (for example squares whose sides are just a few microns long) having predetermined mechanical stress values.

The process for making the film is simple and effective and is fully automated. Therefore, it can be used at industrial level, in a continuous process. It allows the production of high quality films (in terms of the optical properties of the film and the resolution of the images) and high resolution with particularly low production costs.

The costs are lowered mainly thanks to the innovative process of selectively adjusting the level of mechanical stress on basic portions of a face of the optically active layer 2.

1. A film (1) depicting a colour two-dimensional image which is only visible through a polarizing filter, having an optically active layer (2) placed over a polarizing layer (3) and configured to form said image on its face opposite the polarizing layer (3) when said face is seen through the polarizing filter,
the film being characterised in that:
said polarizing layer (3) and said optically active layer (2) are transparent, to allow light to pass through the multi-layer film (1);
the optically active layer comprises a plurality of areas (4) arranged side by side in said face to form corresponding portions of the image, each area (4) being mechanically stressed to a predetermined intensity so that the corresponding portion of the image has a predetermined colour when seen through the polarizing filter.

2. The film according to claim 1, wherein the optically active layer (2) comprises a sheet of plastic material which is mechanically stressed in a predetermined direction.

3. The film according to claim 1, wherein at least one of the areas (4) comprises a plurality of portions having levels of mechanical stress corresponding to two or more reference values and arranged side by side in the surface formed by said area (4) in such a way that the adjacent portions have different levels of mechanical stress, so that from a predetermined distance from the film (1), the portion of the image corresponding to that area (4) is perceived to have a colour corresponding to an intermediate mechanical stress level value relative to the reference values.

4. The film according to claim 1, comprising an adhesive layer (5) applied to a face of the polarizing layer (3) opposite the optically active layer (2), for applying the film (1) to a support.

5. A reel comprising a film according to claim 1, wherein the optically active layer (2) is configured in such a way as to form a plurality of images side by side along a direction of extension of the film (1), the film (1) being wound about an axis perpendicular to said direction of extension to form the reel.

6. A process for making a multi-layer film (1) depicting a colour two-dimensional image which is only visible through a polarizing filter, characterised in that it comprises the following steps:
preparing a polarizing layer (3), said polarizing layer (3) being transparent, to allow light to pass through the multi-layer film (1);
preparing an optically active layer (2), said optically active layer (2) being transparent, to allow light to pass through the multi-layer film (1);
placing the optically active layer (2) over the polarizing layer (3), the optically active layer (2) being configured to form said image on its face opposite the polarizing layer (3) when said face is seen through the polarizing filter,
the process being characterised in that preparation of the optically active layer (2) comprises the following steps:
preparing a sheet of plastic material;
treating a plurality of areas (4) of the sheet to assign each area (4) a mechanical stress of predetermined intensity, said areas (4) being arranged side by side in said face to form corresponding portions of the image, so that the portion of the image corresponding to each treated area (4) has a predetermined colour when seen through the polarizing filter.

7. The process according to claim 6, wherein the sheet is a sheet of plastic material which is mechanically stressed in a predetermined direction and wherein the treatment step comprises transferring thermal energy, according to predetermined quantities for each area (4).

8. The process according to claim 7, comprising a preliminary calibration step, for associating sheet mechanical stress intensity values, corresponding to film (1) desired optical properties, with corresponding values of thermal energy transmitted to the sheet.

9. The process according to claim 6, wherein the sheet is a sheet of plastic material and wherein the treatment step comprises a mechanical action on the surface of the sheet, with a predetermined force for each area, thus assigning each area a mechanical stress of predetermined intensity.

10. An apparatus (6) for making a multi-layer film (1) depicting a colour two-dimensional image which is only visible through a polarizing filter, comprising:
a feeder for feeding sheets of plastic material to a treatment station;
means for selectively assigning to a plurality of areas (4) of the sheet, arranged side by side to form corresponding portions of the image, a mechanical stress of predetermined intensity, thus forming an optically active layer (2), the portions of the image corresponding to areas (4) of the optically active layer (2) having predetermined colours when seen through the polarizing filter;
means for placing a polarizing layer (3) in a gluing station;
a gluer for applying the optically active layer (2) to the polarizing layer (3) in the gluing station.

11. The apparatus according to claim 10, wherein the means for selectively assigning each of the areas of the sheet mechanical stresses of predetermined intensity comprise a heater (7) configured to transfer thermal energy to portions of the sheet, according to predetermined quantities for each area (4), the sheet being a sheet of plastic material mechanically stressed in a predetermined direction.
